(19) United States
(12) Patent Application Publication
(10) Pub. No.: US 2009/0128820 A1
(43) Pub. Date: May 21, 2009

(54) OPTICAL SYSTEM AND ATOMIC OSCILLATOR BACKGROUND

(75) Inventor: Hiroshi NOMURA, Chigasaki (JP)

Correspondence Address: HARNESS, DICKEY & PIERCE, P.L.C., P.O. BOX 828, BLOOMFIELD HILLS, MI, 48303, US

(73) Assignee: EPSON TOYOCOM CORPORATION, Tokyo (JP)

(21) Appl. No.: 12/271,057

(22) Filed: Nov. 14, 2008

(30) Foreign Application Priority Data
Nov. 20, 2007 (JP) 2007-300183

(51) Int. Cl. G01N 21/61

(52) U.S. Cl. 356/437

(57) ABSTRACT

An optical system of an atomic oscillator includes: a coherent light source emitting two resonant light components each having a p-polarized light component and an s-polarized light component, the tow resonant light components being coherent light and having a different frequency each other; a polarization splitter arranged at an output side of the coherent light source, the polarization splitter transmitting one of the p-polarized light component and the s-polarized light component and changes an optical path of the other of the p-polarized light component and the s-polarized light component to be outputted; a quarter-wave plate arranged at an output side of the polarization splitter so as to convert one of circularly polarized light and linearly polarized light to the other of circularly polarized light and linearly polarized light; a gas cell in which metal atom vapor is enclosed; a light guide that guides light after passing through the gas cell back to the gas cell as a turned-back light; and a photodetector that detects the turned-back light, the turned-back light having been passed through the gas cell and changed the optical path by the polarization splitter. The atomic oscillator controls an oscillation frequency by using a light absorption characteristic caused by a quantum-interference effect when the two resonant light components are incident on the optical system.

### BACKGROUND

1. Technical Field

The present invention relates to an optical system of an atomic oscillator, particularly to a mounting technique of a light source and a light receiving element included in the optical system constituting the atomic oscillator.

2. Related Art

Atomic oscillators using alkali metals such as rubidium and cesium include gas cells in which atoms are enclosed in an airtight manner, and those gas cells are operated in a high temperature for keeping the atoms in a gaseous form so that energy transition of atoms are utilized for atomic oscillator. Operating principles of atomic oscillators are broadly classified into two methods; a double resonance method that uses light and microwave, and a method that uses the quantum interference effect caused by two types of laser beams (hereafter referred to as “coherent population trapping” or CPT). In both methods, a detector installed on the side opposite to the gas cell detects how much light incident on the gas cell is absorbed by the atomic gas and thereby detects atomic resonance, so that a control system obtains an output in a state in which a reference signal of a crystal oscillator and the like is synchronized with this atomic resonance. Here, the atomic oscillator using CPT includes an optical system in which a light emitting element, a gas cell, and a light receiving element are integrally structured (refer to U.S. Pat. No. 6,806,784B2).

However, the optical system disclosed in U.S. Pat. No. 6,806,784B2 includes, as shown in FIG. 5, a light emitting element 93, a gas cell 95, and a light receiving element 90. These components are layered on top of one another. This increases the length of a bonding wiring 91 that electrically connects the light receiving element 90 arranged at a top surface, making the mounting structure of modules complex. Moreover, signals obtained at the light receiving element 90 are weak, making the module susceptible to effects of noise superimposed on wires, thereby resulting in less desirable S/N characteristics.

Further, as shown in FIG. 6, another optical system according to another invention by the same inventor of this application includes a light emitting element 102 and a light receiving element 104 mounted on the same substrate 112, as well as a reflection mirror 110 provided on a gas cell 103, so that a resonant light 113 emitted from the light emitting element 102 is transmitted through the gas cell 103, and is reflected by the reflection mirror 110, thereby re-entering the gas cell 103. Thereafter, the light receiving element 104 receives the resonant light 113.

This reflection mirror 110 needs to be inclined at a predetermined angle with respect to the substrate due to a need to arrange the light emitting element 102 and the light receiving element 104 on the same substrate with a space therebetween. As a result, it is necessary to adjust the angle of the reflection mirror 110, increasing the complexity in the adjustment. Moreover, the inclination of the reflection mirror 110 results in a height increase of the entire optical system, which goes against the miniaturization of the optical system.

### SUMMARY

An advantage of the present invention is to provide an atomic oscillator that includes an optical system that has improved signal-to-noise (S/N) characteristics and is easily mounted as a module. This is achieved by reducing the length of the bonding wiring electrically coupled with the receiving element, using a structure where a light receiving element and a light emitting element are closely arranged on the same side relative to the gas cell. In the structure, light emitted from a light emitting element is shifted by λ/4 with a polarizing element and turned back, so that light travels back and forth inside a gas cell with orthogonal polarization states converted by the polarization element and is separated by a polarization separating element to change the optical path.

According to a first aspect of the invention, an optical system of an atomic oscillator includes: a coherent light source emitting two resonant light components each having a p-polarized light component or an s-polarized light component, the two resonant light components being coherent light and having a different frequency each other; a polarization splitter arranged at an output side of the coherent light source, the polarization splitter transmitting one of the p-polarized light component and the s-polarized light component and changes an optical path of the other of the p-polarized light component and the s-polarized light component to be outputted; a quarter-wave plate arranged at an output side of the polarization splitter so as to convert one of circularly polarized light and linearly polarized light to the other of circularly polarized light and linearly polarized light; a gas cell in which metal atom vapor is enclosed; a light guide that guides light after passing through the gas cell back to the gas cell as turned-back light; and a photodetector that detects the turned-back light, the turned-back light having been passed through the gas cell and changed the optical path by the polarization splitter. In this optical system, the atomic oscillator controls an oscillation frequency by using a light absorption characteristic caused by a quantum-interference effect when the two resonant light components are incident on the optical system.

The atomic oscillator uses the quantum interference effect of the coherent light such as laser light. In a three-level system (for instance, a Λ (lambda) type level system), two ground levels each receiving a resonant light component are in a resonant coupling state relative to a common excitation level. Here, if the frequency difference between the two resonant light components irradiated simultaneously accurately match the energy difference between a ground level 1 and a ground level 2, then the three-level system becomes a state of superposition of the two ground levels. As a result, the excitation to an excitation level 3 is stopped. CPT uses this principle in order to detect a state in which the light absorption in the gas cell stops when one or both of the two wavelengths of the resonant light components change.

In the optical system, the coherent light source and the photodetector are both mounted on the same side relative to the gas cell, and the polarization splitter transmits a p-polarized light component included in the resonant light component emitted from the coherent light source, and the quarter-wave plate converts the p-polarized light component to circular polarized light. The circularly polarized light passes through the gas cell, and after being reflected by the light guide, passes through the gas cell again. Thereafter, the quarter-wave plate converts the circularly polarized light to linearly polarized light, i.e., the s-polarized light component. Then, the s-polarized light component is detected by the photodetector. Consequently, the polarization splitter allows the resonant light components to travel back and forth inside the gas cell.

Moreover, the circularly polarized light passing through the gas cell may be reflected by the light guide so as to turn back a same optical path.

A phenomenon called Doppler Broadening occurs when light passes through the gas cell. This phenomenon is expected to be canceled by light traveling back and forth along the same optical path. Therefore, in the optical system, the light guide is arranged so that the light that has passed through the gas cell passes the same optical path so as to cancel the Doppler broadening.

In this case, the photodetector and the coherent light source may be arranged at the same side relative to the gas cell.

The optical system includes the polarization splitter so that the photodetector receives the transmitted light. As a result, the length of the bonding wire is shortened, the S/N characteristics of signals are improved, and the whole optical system can be easily mounted.

In this case, at least one of the gas cell and the light guide may be arranged on the same optical path.

It is sufficient that the gas cell and the light guide are included only in an optical path in which light passes. Therefore, a gas cell and a light guide located where light does not pass are not essential. Therefore, in the optical system, at least one of the gas cell and the light guide is arranged only in the part designed to be on the optical path. This enables reducing the size of the gas cell and the light guide to be minimized, thereby reducing costs of components.

In this case, the light guide may be formed with a reflective member.

The reflective member such as a mirror is optimal for reflecting the circularly polarized light incident on the light guide along the same optical path. Consequently, the circularly polarized light returns to the same optical path through which the circularly polarized light entered.

In this case, the coherent light may be laser light.

Most light has a phase that varies randomly with various wavelengths mixed therein. In contrast, laser light has good monochromaticity and coherent phases. Stability of wavelength and phase of such light is defined as coherence. Light with a high coherence, or in other words, with stable wavelength and phases, induces the quantum interference effect. Laser light is optimal in this respect.

In this case, the metal atom in a vapor state may include one of rubidium and cesium. Using cesium atoms enables achievement of a highly precise atomic oscillator. Rubidium atoms are a widely supplied, readily available material. Either one of those elements may be optionally selected with consideration of required performance and costs.

In this case, a passive optical device may be arranged between the coherent light source and the gas cell so as to collect light emitted from the coherent light source and correct it into collimated light.

In this optical system, such passive optical devices include a lens and a wave plate. This passive optical device may be arranged anywhere in front of a light incidence surface of the gas cell. Here, the passive optical device is arranged between the coherent light source and the gas cell. Consequently, the light is accurately incident on the light guide.

According to a second aspect of the invention, an atomic oscillator includes the optical system of the first aspect.

The optical system in which the light passes the gas cell several times produces stronger EIT signals, thereby providing an atomic oscillator with enhanced performance and improved S/N characteristics.

### BRIEF DESCRIPTION OF THE DRAWINGS

The invention will be described with reference to the accompanying drawings, wherein like numbers reference like elements.

FIG. 1 is a block diagram illustrating a main part of an optical system of an atomic oscillator according to embodiments of the invention.

FIG. 2 is a drawing for describing a three-level system of an atom in the CPT method.

FIG. 3 is a schematic view illustrating the structure of an optical system according to an embodiment of the invention.

FIG. 4 is a schematic view illustrating the structure of an optical system according to another embodiment of the invention.

FIG. 5 is a drawing illustrating the structure of an optical system disclosed in U.S. Pat. No. 6,806,784B2.

FIG. 6 is a drawing illustrating the structure of another optical system developed by the same inventor of this application.

### DESCRIPTION OF EXEMPLARY EMBODIMENTS

Embodiments of the invention are described with reference to the accompanying drawings. The elements, kinds, combinations, shapes, and relational arrangements thereof that are described in the embodiments are examples only and do not limit the scope of the invention thereto unless otherwise specifically described.

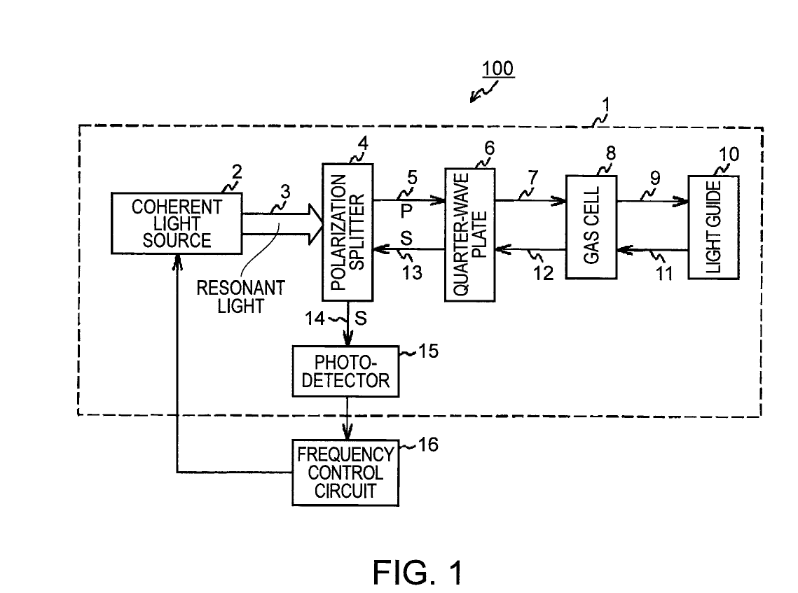

FIG. 1 is a block diagram illustrating a main part of an optical system of an atomic oscillator according to the embodiments of the invention. An optical system 1 is included in an atomic oscillator 100 that controls an oscillation frequency by using a light absorption characteristic caused by the quantum interference effect occurring when two resonant light components having a different frequency each other are incident as a coherent light on the atomic oscillator 100. The optical system 1 includes: a coherent light source 2 emitting a resonant light 3 having two resonant light components; a polarization splitter 4 arranged at the output side of the coherent light source 2 so as to transmit p-polarized (linearly polarized) light included in the resonant light 3 and change an optical path of a s-polarized (linearly polarized) light 13 into a s-polarized light 14; a quarter-wave (λ/4) plate 6 arranged at the output side of the polarization splitter 4 so as to convert one of circularly polarized light and linearly polarized light to the other of circularly polarized light and linearly polarized light; a gas cell 8 in which metal atom vapor is enclosed; a light guide 10 that guides light that has passed through the gas cell 8 back to the gas cell 8; and a photodetector 15 that detects the s-polarized light 14 after passing through the polarization splitter 4 in which the optical path of the s-polarized light 13 is changed.

The atomic oscillator 100 further includes a frequency control circuit 16 that controls the oscillation frequency with an output signal of the photodetector 15.

A circularly polarized light 11 reflected by the light guide 10 enters the gas cell 8 again as turned-back light and becomes a circularly polarized light 12. Thereafter, the circularly polarized light 12 is converted to an s-polarized light 13 (linearly polarized light) by the quarter-wave plate 6 and enters the polarization splitter 4. A detailed description of frequency control of the atomic oscillator is omitted, since the main scope of the invention is the structure of an optical system constituting an atomic oscillator.

The atomic oscillator 100 according to the embodiments uses the quantum interference effect of coherent light such as laser light. In a three-level system (for instance, a Λ (lambda) type level system), two ground levels each receiving resonant light are in a resonant coupling state relative to a common excitation level. Here, if the frequency difference between the two resonant light components in the resonant light simultaneously irradiated accurately match the energy difference between a ground level 1 and a ground level 2, then the three-level system becomes a state of superposition of the two ground levels. As a result, the excitation to an excitation level 3 is stopped.

CPT uses this principle in order to detect a state in which the light absorption in the gas cell stops when one or both of the two wavelengths of the resonant light components change.

In the optical system 1 of the invention, the coherent light source 2 and the photodetector 15 are both mounted on the same side relative to the gas cell 8. Moreover, the polarization splitter 4 transmits a p-polarized light 5 included in the resonant light 3 emitted from the coherent light source 2, and the quarter-wave plate 6 converts the p-polarized light 5 to a circularly polarized light 7. The circularly polarized light 7 passes through the gas cell 8 and is reflected by the light guide 10 so as to pass through the gas cell 8 again as turned-back light. Thereafter, the quarter-wave plate 6 converts the circularly polarized light 12 to a linearly polarized light, i.e., the s-polarized light 13. Then the s-polarized light 3 is separated by the polarization splitter 4 so as to be detected by the photodetector 15. Consequently, the polarization splitter 4 allows the resonant light 3 to travel back and forth inside the gas cell 8.

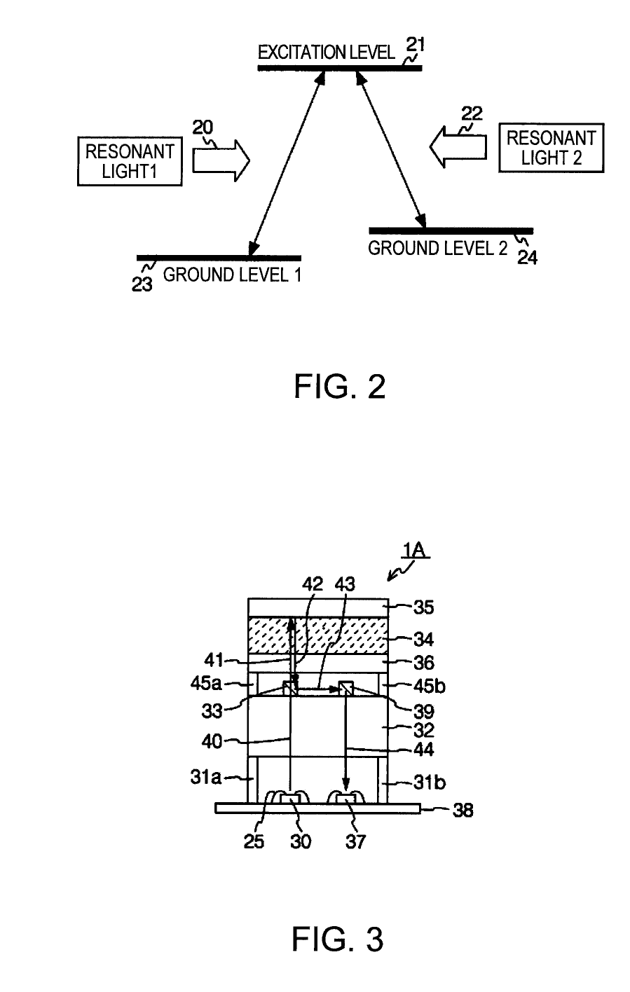

FIG. 2 is a drawing for describing a three-level system of an atom in the CPT method. Rubidium and cesium used in the atomic oscillators have two types of ground levels due to a hyperfine structure originating from electron and nuclear spin interactions. Atoms in these ground levels absorb light and are excited to a higher energy level.

As shown in FIG. 2, a state in which two ground levels receive light and are in a resonant coupling state relative to a common excitation level is called a two-photon resonance.

Referring to FIG. 2, the ground level 1 (23) and the ground level 2 (24) have slightly different energy levels, and thus the resonant light includes a resonant light component 1 (20) and a resonant light component 2 (22) with different wavelengths. If the frequency (wavelength) difference between the simultaneously irradiated resonant light component 1 (20) and the resonant light component 2 (22) accurately matches the energy difference between the ground level 1 (23) and the ground level 2 (24), then the system shown in FIG. 2 produces a state of superposition of the two ground levels, and therefore excitation of atoms to an excitation level 21 stops. CPT uses this principle in order to detect a state in which the light absorption (in other words, transformation to the excitation level 21) in the gas cell 3 stops when one or both of the two wavelengths of the resonant light component 1 (20) and the resonant light component 2 (22) change. Signals produced by the transmitted light passing through the gas cell 3 in a state of no light absorption are referred to as electromagnetically induced transparency (EIT) signals.

FIG. 3 is a schematic view illustrating the structure of an optical system according to a first embodiment of the invention. An optical system 1A includes a light emitting element 30 (the coherent light source 2 in FIG. 1) and a light receiving element 37 (the photodetector 15 in FIG. 1) on a substrate 38, and each element is electrically coupled to the substrate 38 with a bonding wire 25. The optical system 1A further includes a passive optical device 32 that collects a coherent light 40 emitted from the light emitting element 30 so as to convert the coherent light 40 into collimated light and change the polarization state of the coherent light 40. Moreover, the optical system 1A includes, on the passive optical device 32, a beam splitter 33 and a second mirror 39 that guides s-polarized light to the substrate 38, the s-polarized light being changed the optical path by the beam splitter 33. Further, a quarter-wave (λ/4) plate 36, a gas cell 34, and a first mirror 35 are layered above the second mirror 39, with a predetermined distance ensured by spacers 45a and 45b.

The operation of the optical system 1A will now be outlined with reference to FIG. 3. The coherent light 40 emitted from the light emitting element 30 is collected by the passive optical device 32 and is corrected into collimated light which enters the beam splitter 33 (polarization splitter). The coherent light 40 includes two coherent light components each having an s-polarized light component or a p-polarized light component. Hereinafter, two s-polarized light components refer to as the s-polarized light component while two p-polarized light components refer to as the p-polarized light component for the sake of convenience for making descriptions clearly understandable. The beam splitter 33 transmits only the p-polarized light component, while the coherent light 40 includes the p-polarized light component and the s-polarized light component. A p-polarized light component 41, after passing through the beam splitter 33, is converted to circularly polarized light by the quarter-wave plate 36, and enters the gas cell 34.

The gas cell 34 stops the light absorption when one or both of the two wavelengths of the circularly polarized light change. The circularly polarized light, after passing through the gas cell 34, is reflected by the first mirror 35, and re-enters the gas cell 34 along the same optical path. At this time, it is known that a phenomenon called Doppler Broadening occurs when light passes through the gas cell 34. This phenomenon is further described. Atoms inside the cell are distributed in various speed levels. When various-speed atoms contribute to the EIT phenomenon, the Doppler effect changes an apparent wavelength of light for those various-speed atoms, thereby widening the detection width (range of wavelength in which the light absorption in the gas cell stops) under the condition of the EIT phenomenon. This phenomenon is expected to be canceled by light traveling back and forth along the same optical path.

Therefore, in this embodiment, the first mirror 35 is adapted to be orthogonal to the optical path of the circularly polarized light, so that a circularly polarized light 42 that has passed the gas cell 34 passes the same optical path. Consequently, the circularly polarized light is totally reflected to cancel the Doppler broadening effect. The circularly polarized light 42, after passing through the gas cell 34, is converted to s-polarized (linear) light by the quarter-wave plate 36 and re-enters the beam splitter 33. A polarizing beam splitter (PBS) is used for the beam splitter 33. The PBS has a property of transmitting the p-polarized light component without transmitting the s-polarized light component so as to change the optical path of the s-polarized light component. The s-polarized light component is changed the optical path by 90 degrees in the beam splitter 33 as an s-polarized light component 43 and enters a second mirror 39. Then the s-polarized light component 43 is reflected at a right angle by the second mirror 39 as an s-polarized light component 44, and is received by the light receiving element 37. Commonly used devices for the light emitting element 30 (hereafter also referred to as the coherent light source 30) and the light receiving element 37 are respectively a vertical-cavity surface-emitting laser (VCSEL) and a photo diode.

In the optical system 1A, the light emitting element 30 and the light receiving element 37 are mounted on the same side relative to the gas cell, and the beam splitter 33 and the second mirror 39 are adapted so that the light receiving element 37 receives the transmitted light. This allows the length of the bonding wire 25 to be shortened, the S/N characteristics of signals to be improved, and the entire optical system 1A to be easily mounted.

The beam splitter 33 transmits the p-polarized light component included in the coherent light 40, while changes the optical path of the s-polarized light component. Therefore, according to the invention, the p-polarized light component that has passed through the beam splitter 33 is converted to circularly polarized light when passing through the quarter-wave plate 36, and this circularly polarized light passes trough the gas cell 34, and is reflected thereafter by the first mirror 35 so as to be turned back the same optical path, thereby passing through the gas cell 34 again as the circularly polarized light. The quarter-wave plate 36 then converts this circularly polarized light to s-polarized light and the beam splitter 33 changes the optical path thereof. That is, the beam splitter 33 can separate optical paths.

Laser light is used for the light emitting element 30 in this embodiment. Laser light has good monochromaticity and coherent phases. Stability of wavelength and phase of such light is defined as coherence. Light with a high coherence, or in other words, with stable wavelength and phase, induces the quantum interference effect. Laser light is optimal in this respect.

The metal atom in a vapor state used for the gas cell 34 includes rubidium or cesium. Using cesium atoms used for primary atomic frequency standard enables achievement of a highly precise atomic oscillator. Rubidium atoms used for a secondary standard are a widely supplied, readily available material, and, in general, enable a small-sized and inexpensive atomic oscillator.

Characteristics of intended use determine which metal elements are used. While rubidium and cesium are used in this embodiment, any elements with a three-level system such as a Λ type level system may be employed.

Alternatively, the polarization splitter may transmit the s-polarized light component and change the optical path of the p-polarized light component, instead of transmitting the p-polarized light component and changing the optical path of the s-polarized light component.

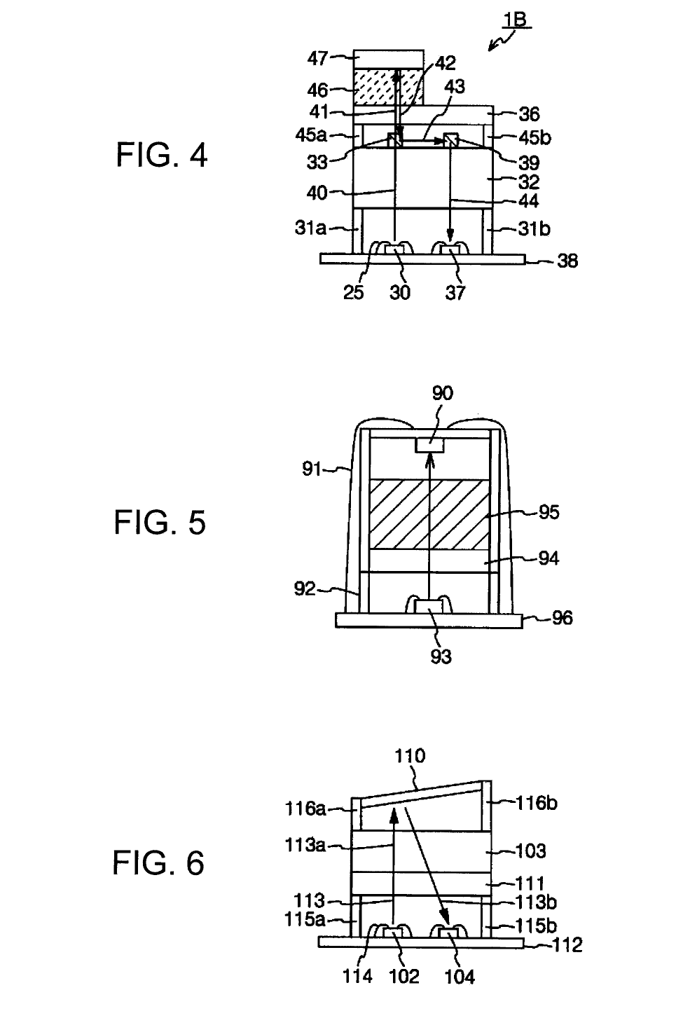

FIG. 4 is a schematic view illustrating the structure of an optical system according to a second embodiment of the invention. The same reference numbers are used for elements similar to those described in FIG. 3. An optical system 1B includes a gas cell 46 and a first mirror 47 arranged within a range that covers an optical path. In other words, it is sufficient that the gas cell 46 and the first mirror 47 are included only in an optical path in which light passes.

Therefore, the gas cell 46 and the first mirror 47, located where light does not pass, are not essential. Therefore, in this embodiment, the gas cell 46 and/or the first mirror 47 is arranged only in the part that is designated to become the optical path. This enables reducing the size of the gas cell 46 and the first mirror 47 to a minimum, thereby reducing costs for components. Similarly, it is sufficient that the quarter-wave plate 36 is in the optical path, allowing the reduction of the size thereof.

What is claimed is:

1. An optical system of an atomic oscillator, comprising:
a coherent light source emitting two resonant light components each having a p-polarized light component or a s-polarized light component, the two resonant light components being coherent light and having a different frequency each other;
a polarization splitter arranged at an output side of the coherent light source, the polarization splitter transmitting one of the p-polarized light component and the s-polarized light component and changes an optical path of the other of the p-polarized light component and the s-polarized light component to be outputted;
a quarter-wave plate arranged at an output side of the polarization splitter so as to convert one of circularly polarized light and linearly polarized light to the other of circularly polarized light and linearly polarized light;
a gas cell in which metal atom vapor is enclosed;
a light guide that guides light after passing through the gas cell back to the gas cell as turned-back light; and
a photodetector that detects the turned-back light, the turned-back light having been passed through the gas cell and changed the optical path by the polarization splitter, wherein the atomic oscillator controls an oscillation frequency by using a light absorption characteristic caused by a quantum-interference effect when the two resonant light components are incident on the optical system.

2. The optical system of an atomic oscillator according to claim 1, wherein the light after passing through the gas cell is reflected by the light guide so as to turn-back a same optical path.

3. The optical system of an atomic oscillator according to claim 1, wherein the photodetector and the coherent light source are arranged at a same side relative to the gas cell.

4. The optical system of an atomic oscillator according to claim 2, wherein at least one of the gas cell and the light guide is arranged on the same optical path.

5. The optical system of an atomic oscillator according to claim 1, wherein the light guide is formed with a reflective member.

6. The optical system of an atomic oscillator according to claim 1, wherein the coherent light is laser light.

7. The optical system of an atomic oscillator according to claim 1, wherein the metal atom in a vapor state includes one of rubidium and cesium.

8. The optical system of an atomic oscillator according to claim 1, further comprising a passive optical device that collects light emitted from the coherent light source and corrects the light into collimated light, the passive optical device being arranged between the coherent light source and the gas cell.

9. An atomic oscillator, comprising the optical system according to claim 1.
